(19) United States
(12) Patent Application Publication
(10) Pub. No.: US 2024/0114324 A1
(43) Pub. Date: Apr. 4, 2024

(54) METHOD AND DEVICE FOR MANAGING INFORMATION EXCHANGE BETWEEN NFC CONTROLLER AND AUXILIARY ELEMENTS

(71) Applicants: STMicroelectronics (Rousset) SAS, Rousset (FR); STMICROELECTRONICS GMBH, Aschheim-Dornach (DE)

(72) Inventors: Thierry Meziache, Sainte Baume (FR); Pierre Rizzo, Trets (FR); Alexandre Charles, Auriol (FR); Juergen Boehler, Munich (DE)

(21) Appl. No.: 18/525,496

(22) Filed: Nov. 30, 2023

Related U.S. Application Data
(63) Continuation of application No. 17/649,146, filed on Jan. 27, 2022, now Pat. No. 11,889,397.
Application No. 17/649,146 is a continuation of application No. 16/719,640, filed on Dec. 18, 2019, now Pat. No. 11,272,338.
Application No. 16/719,640 is a continuation of application No. 15/994,607, filed on May 31, 2018, now Pat. No. 10,536,836.
Application No. 15/994,607 is a continuation of application No. 15/335,636, filed on Oct. 27, 2016, now Pat. No. 10,244,372.
Application No. 15/335,636 is a continuation of application No. 13/994,283, filed on Sep. 6, 2013, now Pat. No. 9,515,701.

(30) Foreign Application Priority Data
Dec. 15, 2010 (EP) 10306416.8
Mar. 30, 2011 (EP) 11305359.9

(51) Int. Cl. H04W 4/80; G06K 7/00; G06K 7/10; H04B 5/00

(52) U.S. Cl. CPC H04W 4/80; G06K 7/0008; G06K 7/10237; G06K 7/10247; H04B 5/0031

(57) ABSTRACT

A device, including a main element and a set of at least two auxiliary elements, the main element including a master SWP interface, each auxiliary element including a slave SWP interface connected to the master SWP interface of the NFC element through a controllably switchable SWP link and management circuit configured to control the SWP link switching for selectively activating at once only one slave SWP interface on the SWP link.

### CROSS-REFERENCE TO RELATED APPLICATIONS

This application is a continuation of U.S. application Ser. No. 17/649,146, filed Jan. 27, 2022, which is a continuation of U.S. patent application Ser. No. 16/719,640, filed Dec. 18, 2019, now issued as U.S. Pat. No. 11,272,338, which is a continuation of U.S. patent application Ser. No. 15/994,607, filed May 31, 2018, now U.S. Pat. No. 10,536,836, which application is a continuation of U.S. patent application Ser. No. 15/335,636, filed Oct. 27, 2016, now U.S. Pat. No. 10,244,372, which application is a continuation of U.S. patent application Ser. No. 13/994,283, filed Sep. 6, 2013, now U.S. Pat. No. 9,515,701, which application is a National Stage entry of PCT Application No. PCT/EP2011/072474, filed on Dec. 12, 2011, which application claims priority to EP Patent Application Nos. 11305359.9, filed on Mar. 30, 2011, and 10306416.8, filed on Dec. 15, 2010, which applications are hereby incorporated by reference herein in their entirety.

### TECHNICAL FIELD

The invention relates to the communication between components or elements, in particular between a contactless element, for example, an NFC (“Near Field Communication”) controller element and at least two auxiliary elements, such as a UICC or secure elements, for example, located within a wireless apparatus, for example, a mobile phone.

### BACKGROUND

As defined within ETSI TR 102 216 V3.0.0 (2003-09), UICC, which is neither an abbreviation nor an acronym, designates a smart card that conforms to the specifications written and maintained by the ETSI Smart Card Platform project.

Further to its conventional telephone function, a mobile phone may be used for exchanging information with a contactless device by using a contactless communication protocol.

This permits to exchange of information between the contactless device and elements located within the mobile phone. Plenty of applications are thus possible such as mobile ticketing in public transport (the mobile phone acts as a boarding pass) or mobile payment (the mobile phone acts as a debit/credit payment card).

Near Field Communication or NFC is a short-range high-frequency wireless communication technology that enables such data exchange between two contactless devices over a short distance, for example, 10 centimeters.

NFC is an open platform technology standardized in ISO/IEC 18092 and ISO/IEC 21481 but incorporates a variety of pre-existing standards, including ISO/IEC 14443 protocol type A and type B.

Mobile phone manufacturers are interested in connecting two different auxiliary elements to NFC chips. Having two separate auxiliary elements allows two clearly separate applications coming from different issuers (banks, transport operators, telephone operators, . . . ).

ETSI TS 102 613 is a standard disclosing, in particular, the principle of a so-called Single Wire Protocol (SWP). The SWP is a bit-oriented point-to-point communication protocol between a contactless front end (CLF), called an NFC controller, and a UICC. However, this single wire protocol, as defined in ETSI TS 102 613, permits only the communication between one contactless element, for example, one NFC controller and one UICC.

A first solution for managing information exchange between an NFC controller and two elements consists of providing an NFC controller with one SWP interface for secure elements based on SWP-UICC technology and a second interface (for example, an NFC Wired Interface: NFC-WI) for proprietary secure elements. However, such a solution makes the design of an NFC controller more complex as an additional interface has to be managed in a time-critical environment.

A second solution consists of offering NFC controllers provided with two SWP interfaces. This solution would allow the use of two secure elements provided with SWP-UICC technology, but again, it will make the design of the NFC controller more complex as an additional interface has to be managed.

### SUMMARY

According to an embodiment, a method and a device are proposed for managing in a simple way, information exchange between a contactless element, such as an NFC controller, and several (at least two) auxiliary elements by using the already existing hardware technology without any modification of the software on secure elements provided with SWP-UTCC technology.

According to an aspect, a method of managing information exchange between a main element, in particular, a contactless element, for example, an NFC element such as an NFC controller, and a set of at least two auxiliary elements is provided which comprises providing each auxiliary element with a slave SWP interface, providing the main element with a master SWP interface, connecting the slave SWP interfaces to the master SWP interface through a controllably switchable SWP link and controlling the SWP link switching for selectively activating at once only one slave SWP interface on the SWP link.

A slave SWP interface is considered to be activated when for example, it is capable, after an activation phase including the transmission of particular control data, to exchange information with the master interface on the SWP link related, for example, to a particular contactless application.

According to an embodiment, connecting the slave SWP interfaces to the master SWP interface through a controllably switchable SWP link comprises connecting a controllable multiplexer/demultiplexer switch between the master SWP interface and the slave SWP interfaces and controlling the SWP link switching comprises controlling the multiplexer/demultiplexer switch for switching the SWP link to the selected slave SWP interface.

According to an embodiment, the method further comprises forcing the part of the SWP link connected between each non-selected slave SWP interface and the multiplexer/demultiplexer switch in a deactivated state.

This permits the non-selected slave SWP interface, to simulate the presence of the master element even if this master element is actually exchanging information with the selected slave interface.

Further, as the parts of the SWP link connected between each selected slave SWP interface and the multiplexer/demultiplexer switch are forced in a deactivated state, there is no risk that one of the non-selected slave SWP interface detects a non-working SWP link, while the selected slave SWP interface is active.

An auxiliary element cannot initiate SWP communication while deactivating the SWP link.

According to an embodiment, the method further comprises controlling the SWP link switching when the SWP link is in a deactivated state.

In other words, it is only possible to switch the SWP link to another auxiliary element when the SWP is deactivated. Thus, all auxiliary elements assume a deactivated SWP link and all auxiliary elements will not recognize any change on the SWP link when SWP switching happens.

Activating the selected slave SWP interface may comprise performing an initial activation of the selected slave SWP interface or subsequent activation of the selected slave SWP interface.

According to an embodiment, either all the auxiliary elements operate in a first operation mode, for example, in a full power mode, or only one auxiliary element operates in a second operation mode, for example, in a low power mode, having a power value lower than the power value of the first operation mode, while each other auxiliary element is OFF, and when the only one auxiliary element operates in a second operation mode, controlling the SWP link comprises forcing the SWP link switching into a predetermined configuration allowing the selection of the only one auxiliary element.

This permits a switching of the SWP link to one auxiliary element, even if the multiplexer/demultiplexer switch is not sufficiently powered.

According to another embodiment, either all the auxiliary elements operate in the first operation mode, or at least a first auxiliary element operates in the second operation mode, and when the first auxiliary element operates in a second operation mode, the first auxiliary element controls the SWP link switching for selecting only one auxiliary element operating in a second operation mode.

It is thus possible to have a more flexible configuration in the low power mode.

More particularly, a configuration indication may be stored in the first auxiliary element and the first auxiliary element controls the SWP link switching using the configuration indication.

While it is possible to store the configuration indication during the fabrication of the device, thus fixing a configuration by default for the low operation mode, it is particularly advantageous that, for example, the user of a wireless apparatus may decide the configuration in the low power mode.

In this respect, the configuration indication may be stored in the first auxiliary element when all the auxiliary elements operate in the first operation mode, for example, through a user interface.

According to an embodiment, the first auxiliary element operates in a second operation mode, the first auxiliary element controls the powering of each other auxiliary element to place each other auxiliary element in an OFF state, and the first auxiliary element controls the SWP switching for selecting the first auxiliary element operating in a second operation mode.

According to another embodiment, the first auxiliary element operates in a second operation mode, the first auxiliary element controls the powering of a second auxiliary element to permit the second auxiliary element to operate in a second operation mode and the first auxiliary element controls the SWP link switching for selecting the second element operating in a second operation mode.

The first auxiliary element may control the powering of the second auxiliary element or each other auxiliary element by using the configuration indication.

According to another aspect, a device is proposed, comprising a main element and a set of at least two auxiliary elements, the main element including a master SWP interface, each auxiliary element including a slave SWP interface connected to the master SWP interface of the NFC element through a controllably switchable SWP link and management circuit configured to control the SWP link switching for selectively activating at once only one slave SWP interface on the SWP link.

According to an embodiment, the device comprises a controllable multiplexer/demultiplexer switch having a first terminal coupled to the master SWP interface through a first part of the SWP link and at least two second terminals respectively coupled to the at least two slave SWP interfaces through at least two second parts of the SWP link, and the management circuit comprise control circuit configured to control the multiplexer/demultiplexer switch.

The control circuit may be advantageously located within the main element.

According to an embodiment, the device further comprises first forcing circuit configured to force each second part of the SWP link connected between each non selected slave SWP interface and the multiplexer/demultiplexer switch in a deactivated state.

According to an embodiment, the first forcing circuit comprise at least two pull-down resistors connected between the at least two second parts of the SWP link and a reference voltage.

According to an embodiment, the management circuit comprise processing circuit configured to put the SWP link in a deactivated state, and the control circuit are configured to control the multiplexer/demultiplexer switch after the processing circuit have put the SWP link in the deactivated state.

The management circuit may be configured to perform either an initial or subsequent activation of the selected SWP slave interface.

According to an embodiment, the device has a first state in which all the auxiliary elements can operate in a first operation mode, for example, in a full power mode, and a second state in which only one auxiliary element can operate in a second operation mode, for example in a low power mode, having a power value lower than the power value of the first operation mode, and each other auxiliary element is OFF, and the device further comprises second forcing circuit configured, when the link switching into further comprises second forcing circuit the device is in its second state, to force the SWP a predetermined configuration allowing the selection of the only one auxiliary element.

According to an embodiment, the second forcing circuit comprise another pull-down resistor connected between the control input of the multiplexer/demultiplexer switch and a voltage reference.

According to a variant, the device has a first state in which all the auxiliary elements can operate in the first operation mode, and a second state in which at least a first auxiliary element can operate in the second operation mode, and the device comprises auxiliary selection circuit at least partly incorporated in the first auxiliary element and configured, when the device is in its second state, to control the SWP link switching for selecting only one auxiliary element operating in a second operation mode.

According to an embodiment, the auxiliary selection circuit comprises an auxiliary memory circuit incorporated in the first auxiliary element for storing a configuration indication, and an auxiliary control circuit configured to control the SWP link switching from the configuration indication.

The auxiliary selection circuit may further comprise an auxiliary input circuit configured to store the configuration indication in the auxiliary memory circuit when the device is in its first state.

The auxiliary selection circuit may be further configured, when the device is in its second state, to control the powering of each other auxiliary element to place each other auxiliary element in an OFF state and to select the first auxiliary element operating in a second operation mode.

The auxiliary selection circuit may also be configured, when the device is in its second state, to control the powering of a second auxiliary element to permit the second auxiliary element to operate in a second operation mode, and to select the second element operating in a second operation mode.

According to an embodiment, the auxiliary selection circuit comprises an auxiliary power control circuit configured to control the powering of the second auxiliary element or each other auxiliary element from the configuration indication.

According to an embodiment, one auxiliary element may be packed with the main element and another auxiliary element, for example a SIM card, may be removably connected to the main element.

The main element may be a contactless element, for example an NFC controller.

According to another aspect, an apparatus, for example, a wireless communication apparatus, is proposed comprising an antenna and a device, as defined above, coupled to the antenna.

According to an embodiment, one auxiliary element may be permanently fixed within the apparatus and another auxiliary element, for example, a SIM card, may be removably lodged within the apparatus and removably connected to the main element.

### BRIEF DESCRIPTION OF THE DRAWINGS

Other advantages and features of the invention will appear on examining the detailed description of embodiments, these being in no way limiting, and of the appended drawings in which:

FIG. 1 illustrates schematically an embodiment of a device according to the invention;

FIGS. 2 and 3 illustrate connections between a main element and auxiliary elements through a SWP link;

FIGS. 4, 5a, and 5b illustrate diagrammatically examples of flow charts of several embodiments of a method according to the invention;

FIGS. 6-9 illustrate diagrammatically examples of frames used in embodiments of the present invention;

FIGS. 10 and 11 illustrate diagrammatically other examples of flow charts related to initial and subsequent activations;

FIG. 12 illustrates diagrammatically an embodiment of a multiplexer-demultiplexer switch in the present invention;

FIGS. 13 and 14 illustrate diagrammatical embodiments of a wireless apparatus according to the invention; and

FIGS. 15 to 18 illustrate diagrammatically other embodiments of a method and a wireless apparatus according to the invention.

### DETAILED DESCRIPTION OF ILLUSTRATIVE EMBODIMENTS

Embodiments of the invention will now be described in the technical field of contactless elements or components connected to secure elements, in particular, embedded in a mobile phone, although the invention is not limited to these particular embodiments.

A contactless element is an element or a component able to exchange information through an antenna with a contactless device according to a contactless communication protocol.

An NFC element or component, which is a contactless element, is an element or component compliant with the NFC technology.

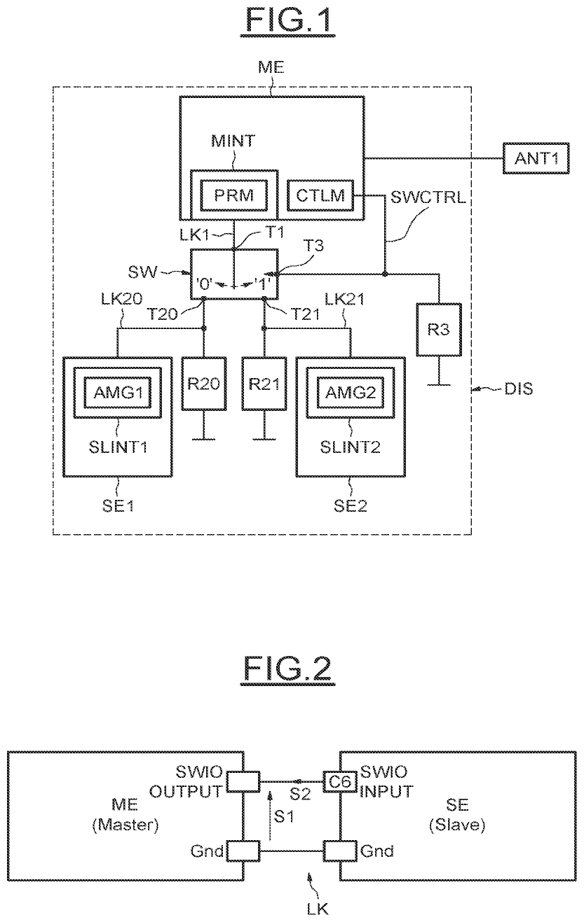

In FIG. 1, an example of a device DIS according to the invention is illustrated, which comprises a contactless front end element ME, for example, an NFC controller, having a SWP interface MINT.

The device also comprises two auxiliary elements or secure elements. Each secure element SEI (SE2) comprises a SWP interface SLINT 1 (SLINT 2). Each SWP interface SLINTi is connected to the same SWP interface MINT of the NFC controller ME through a controllably switchable SWP link LK.

A secure element is, for example, an element adapted to contain secure or protected information, for example, banking information and information related to telephone subscriptions, among others.

Each SWP interface SLINTi comprises an auxiliary management circuit AMGi, while the SWP interface MINT of the NFC controller ME comprises a processing circuit PRM.

The NFC controller ME is coupled to an antenna ANTI for exchanging information with a contactless reader by using a contactless communication protocol, for example, the one disclosed in ISO/IEC 14443.

The Single Wire Protocol (SWP) is a bit-oriented, point-to-point communication protocol between a secure element and a contactless front end, and is specified in the standard ETSI TS 102 613, for example, the version V7.7.0 (2009-10) thereof. The man skilled in the art could refer, if necessary, to this document, the content incorporated by reference in the present patent application.

More precisely, as illustrated in FIG. 2, the NFC controller ME is the master, whereas a secure element SE is a slave. The master and a slave are mutually connected through an SWP link LK.

An SWP link is a link or line adapted to support the Single Wire Protocol (SWP).

As disclosed in ETSI TS 102 613, the principle of the single wire protocol (SWP) is based on transmitting digital information in full-duplex mode. The signal S1 from ME to SE is transmitted by a digital modulation (L or H) in the voltage domain, whereas the signal S2 from SE to ME is transmitted by a digital modulation (L or H) in the current domain.

When the master sends S1 as state H then the slave may either draw a current (state H) or not (state L) and thus transmits S2. With pulse width modulation bit coding of S1, it is possible to transmit a transmission clock, as well as data in full-duplex mode. More details can be found in ETSI TS 102 613.

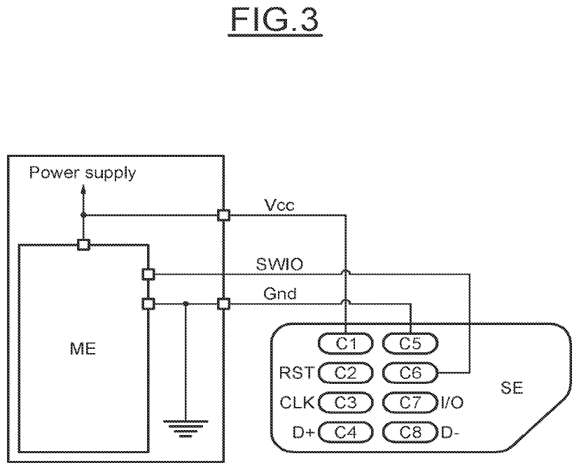

FIG. 3 represents an embodiment of the physical link between the contactless element ME and a secure element SE. More precisely, as illustrated in this figure and explained in ETSI TS 102 613, the contact C6 of the secure element is connected to the port SWIO of the contactless element ME for transmission of signals S1 and S2.

The SWP protocol specified in ETSI TS 102 613 permits only the communication between the master SWP interface of the contactless element and a single slave SWP interface of a single secure element.

According to an aspect of the invention which will now be described in more detail, it will be possible to connect two or more two auxiliary elements or secure elements SEi provided with an SWP-UICC technology to a single master SWP interface of a contactless element, for example, an NFC controller.

More precisely, if we refer again to FIG. 1, this will be possible in particular by connecting a controllable multiplexer/demultiplexer switch SW between the master SWP interface MINT and the slave SWP interfaces SLINT1, SLINT2, and by controlling the switch SW by control circuit C TLM for switching the SWP link to the selected slave SWP interface.

Here, the processing circuit PRM, the control circuit CTLM, and the auxiliary management circuit AMGi form management circuit are configured to control the SWP link switching for selectively activating at once only one selected slave SWP interface on the SWP link.

The management circuit and the control circuit may be realized by the software module and at least partly by the logic circuit.

In the present embodiment, where only two auxiliary elements are used, the multiplexer/demultiplexer switch SW has a first terminal T1 coupled to the master SWP interface MINT through a first part LK1 of the SWP link LK and two second terminals T20 and T2 respectively coupled to the two slave SWP interfaces SLINT1, SLINT2 through two second parts LK20, LK21 of the SWP link.

Of course, although the parts LK1, LK20, and LK21 have been represented here by wires between the terminals T1, T20, T21, and the corresponding terminals of the SWP interfaces, these parts may be reduced to the minimum if for example, the terminals T1, T20, T21 respectively meet the corresponding terminals of the SWP interfaces.

The switch SW further comprises a control terminal T3 connected to the control circuit CTLM for receiving a control signal SWCTRL for switching the first terminal T1 to either the second terminal T20 or the second terminal T21, depending on the logic value of the control signal.

For example, as illustrated in FIG. 1, if the control signal SWCTRL has the logic value “0”, the first terminal T1 is connected to the second terminal T20 while the first terminal T1 is connected to the second terminal T21 if the control signal SWCTRL has the logic value “1”.

As defined in ETSI TS 102 613, an SWP link may have an activated state, a suspended state and a deactivated state.

More precisely, in the activated state, the master element and the selected auxiliary element are sending bits.

In the suspended state, the signal S1 is in state H and S2 is in state L.

In the deactivated state, the signal S1 is in state L and the signal S2 is in state L.

As it will be explained in more detail, controlling the switch SW is only performed when the SWP link LK is in its deactivated state.

Further, when a secure element SE 1, for example, has been selected, the part of the SWP link seen by the other non-selected secure element (SE2, for example), is advantageously in a deactivated state.

Placing such part of the SWP link in a deactivated state is equivalent to place the C6 contact of the corresponding non-selected secure element in a low state, typically at ground.

Resistors R20 and R21 respectively connected between the second terminal T20 and a voltage reference, for example, ground, and between second terminal T21 and the voltage reference, are pull-down resistors. And, the pull-down resistor R20 permits to force the part LK20 of the SWP link into a deactivated state when the secure element SE2 has been selected, while pull-down resistor R21 forces the part LK21 of the SWP link into its deactivated state when the secure element SE1 has been selected.

Further, another pull-down resistor R3 connected between the control input T3 and the voltage reference (ground, for example) permits to force the control input to the logical value “0,” thereby forcing the switch in the predetermined configuration in which terminal T1 is connected to terminal T20, in the case the switch SWP is not sufficiently or not at all powered.

The value of each pull-down resistor is chosen to have, for example, a current having a very small value, for example, 5 μA or 10 μA.

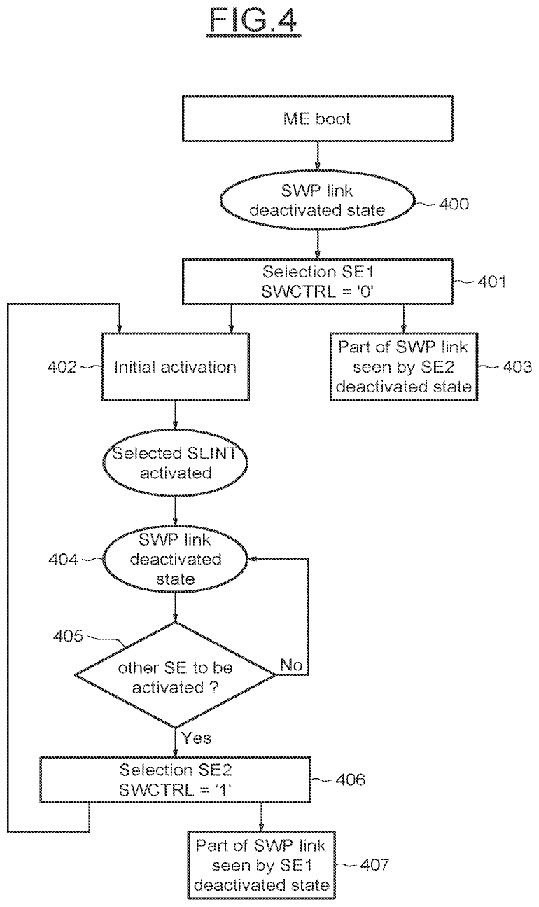

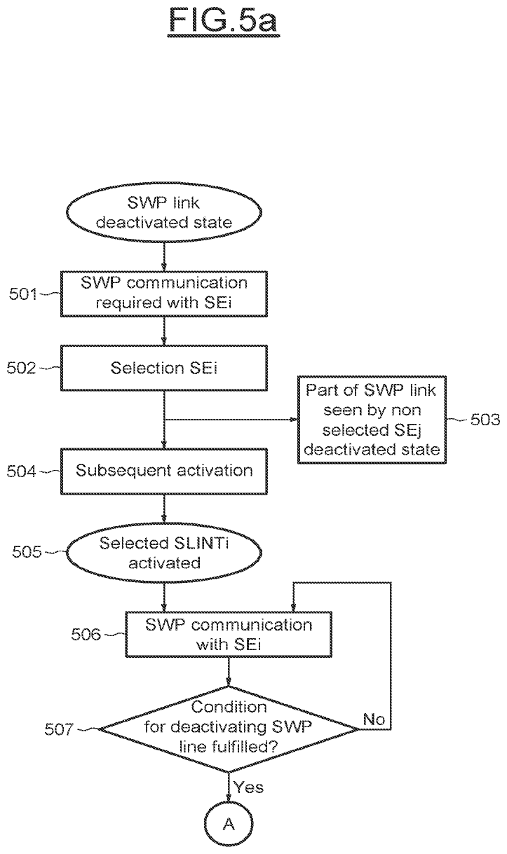

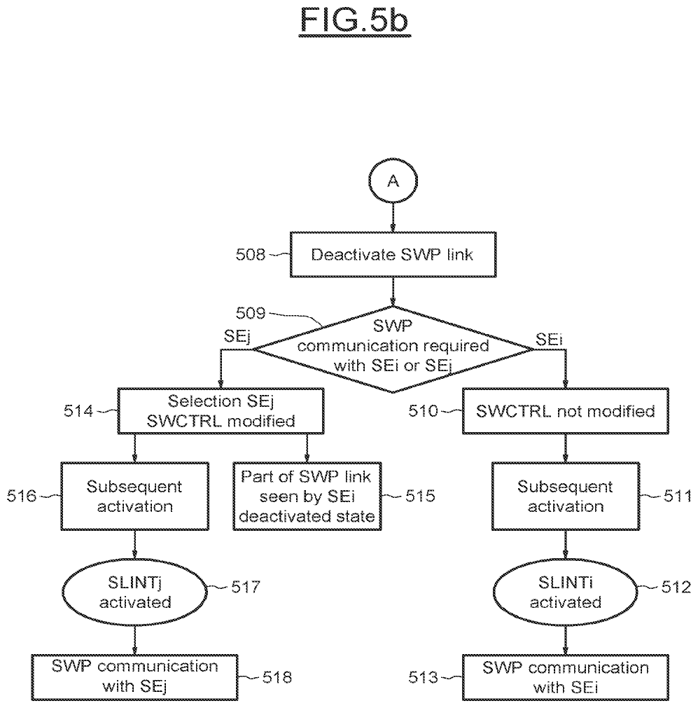

We now refer to FIG. 4, which illustrates a particular embodiment of a method according to the invention.

After the master element boot, the processing circuit PRM of the master element puts the SWP link in its deactivated state (step 400) to select (step 401) one secure element, for example, secure element SE1. In this respect, the control signal SWCTRL has the logic value “o”.

Since the secure element SE1 has been selected, the part LK21 of the SWP link seen by the other non-selected secure element SE2 is forced to be in a deactivated state by the pull-down resistor R21 (the signal S1 is pulled down to state L by the resistor R21).

Of course, as explained above, forcing the part of the SWP link seen by the non-selected secure element in its deactivated state is equivalent to force the potential of the C6 contact of the secure element to a low state (ground, for example).

Once the secure element SE1 has been selected, the management circuit (processing circuit and auxiliary management circuit) perform an initial SWP activation (step 402) of the corresponding slave SWP interface, as defined in ETSI TS 102 613.

Activating a slave SWP interface leads to placing the slave SWP interface in an activated state. For example, activating a slave SWP interface comprises performing an activation phase during which control data are exchanged between the master interface and the slave interface. At the end of the activation phase, the master and the slave have been mutually “recognized,” and the slave is ready to exchange payload information related to a particular contactless application with the contactless element. The slave interface is thus activated (or in an activated state).

Once the initial SWP activation sequence is finished, the processing circuit of the main element ME puts the SWP link into its suspended state, and waits for communication from the activated slave interface of the secure element.

If the conditions are fulfilled to deactivate the secure element, the processing circuit of the main element puts the SWP link in its deactivated state (step 404). Such conditions are, for example, those detailed in point 8.3 of ETSI TS 102 613.

Now, the main element ME can switch the SWP link between the secure element SE1 and the secure element SE2 (step 406).

In this respect, the switch control SWCTRL takes the logic value “1”.

An initial SW activation (step 402) is performed for the secure element SE2, while the part LK20 of the SWP link seen by the non-selected secure element SE1 is forced into its deactivated state by the pull-down resistor R20 (step 407).

For example, an event that can lead to an initial SWP activation of secure element SE2, which is, for example, a UICC, is the reception of a signal from the main processor.

Once the initial SWP activation sequence is finished for the secure element SE2, the processing circuit of the main element ME puts the SWP link into its suspended state to wait for SWP communication from secure element SE2. If no activity is required on this interface, the processing circuit of the main element puts the SWP link in its deactivated state (step 404).

If another secure element SE is to be activated, a new selection is performed, followed by the initial activation of this newly selected secure element (step 402).

If no other secure element is to be activated (step 405), the SWP link remains in its deactivated state.

At this stage, if SWP communication with a secure element SEi is required (step 501) (upon, for example, reception of an external event coming from the application supported by this secure element), this secure element SEi is selected (step 502).

Of course, if the switch SWP is already in the configuration for selecting this secure element, no change is performed on the switch.

Then, a subsequent activation (step 504), as defined in ETSI TS 102 613, is performed for this secure element SEi, while the part of SWP link seen by each non-selected secure element SEj (contact C6 of each non-selected secure element SEj) is in its deactivated state (step 503).

Once the selected slave interface SLINTi of the secure element SEi has been activated (step 505), a SWP communication between the main element ME and this secure element SEi may be performed (step 506) until the conditions are fulfilled allowing to deactivate the SWP link as for example described within chapter 8.3 of ETST TS 102 613, for example, until the reception of a signal named EVT_HCI_END_OF_OPERATION in ETSI TS 102 622 (step 507).

Such a signal indicates the end of communication with the secure element SEi.

After the conditions are fulfilled, the SWP link is put again in its deactivated state (step 508) by the processing circuit PRM of the main element SE.

If a new SW communication is required with the previously selected secure element SEi, thus, the control signal SWCTRL is not modified (step 510) and a subsequent activation (step 511) is performed for activating the slave interface SLINTi of this secure element SEi (step 512) permitting thus the SWP communication with this secure element (Step 513).

If an SWP communication is required with a secure element SEj, different from the previously selected secure element SEi, then, this new secure element SEj is selected (step 514) by modifying the value of the control signal SWCTRL.

A subsequent activation (step 516) is performed for this newly selected secure element SEj, while maintaining the contact C6 of each other non-selected secure element in a low state (step 515).

Once the slave interface SLINTj of this secure element SEj has been activated (step 517), an SWP communication between the main element ME and the secure element SEj may be performed (step 518).

An initial activation and subsequent activation of a slave interface are disclosed in ETSI TS 102 613.

The man skilled in the art may refer to this standard if necessary.

Some details about these activations are now briefly described with reference to FIGS. 6-11.

According to ETSI TS 102 613, particular control frames, called ACT frames, are exchanged between the NFC controller ME and a secure element SE during an activation phase.

Such an ACT frame, referenced CPR, is diagrammatically illustrated in FIG. 6.

More precisely, the first three bits of byte 1 of the frame CPR declare the SWP frame as an ACT frame. The FR bit indicates an eventually corrupted previously received ACT frame (only used by the NCF controller ME). The INF bit indicates that the last payload byte contains the ACT INFORMATION field and the ACT CTRL bits b1 b2 b3 define the meaning of the ACT frame. After byte 1, 0-3 payload bytes follow, the content thereof depending of the content of ACT_CTRL and FR fields.

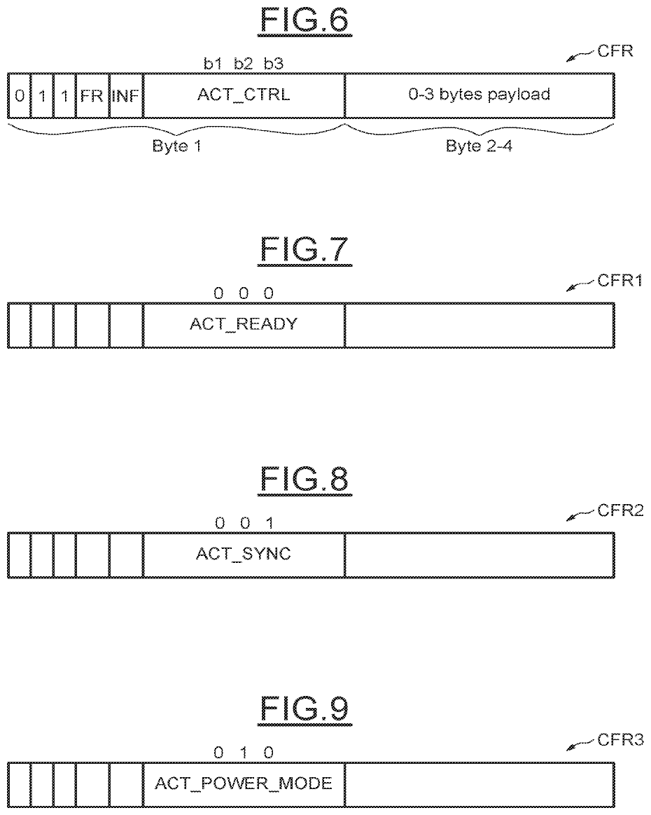

More precisely, when the bits b1 b2 b3 have respectively the binary values 000, the corresponding frame CFR1 is a so-called ACT_READY frame indicating that the secure element has been activated and is ready for exchanging information with the contactless element (FIG. 7).

When the bits b1, b2, b3 have respectively the binary values 001, the corresponding frame CFR2 is a so-called ACT_SYNC frame sent by a secure element and containing the identification SYNC_ID of this secure element (FIG. 8).

When the bits b1 b2 b3 have respectively the binary values 010, the corresponding frame CFR3 (FIG. 9) is a so-called ACT POWER MODE frame sent by the contactless element and indicating the power mode (full power or low power).

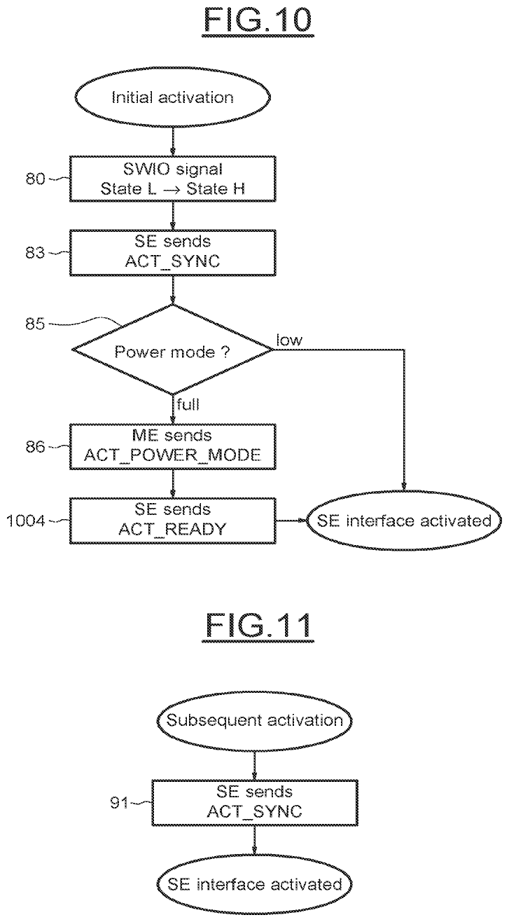

FIG. 10 is more particularly directed to an initial activation of a slave interface. An initial activation is performed in particular after the first powering up of the device or after a new powering up following a power interruption.

First, the SWTO signal (see FIGS. 2 and 3) which is in its low state L is set to its high state H by the NFC controller (state 80). The SWP link is in its suspended state.

In ETSI TS 102 613 a secure element that detects such state H on its contact C6 has a predetermined duration (700 μs) for resuming the SWP link.

The auxiliary management circuit of the slave interface of the secure element SE, which is the selected secure element, sends, after having resumed the SWP link, an ACT_SYNC frame CFR2 (step 83).

Then, the activation process continues depending on the power mode (step 85).

More precisely, the NFC controller ME sends an ACT_POWER_MODE frame CFR3 (step 86) in the case of a full power mode.

Upon receipt of this frame CFR3, the auxiliary management circuit of the selected secure element SE sends an ACT READY frame CFR1 (step 87).

The SWP interface of the secure element SEn is thus considered activated.

If the power mode is a low power mode, the interface of the selected secure element SE is considered to be activated after step 83.

FIG. 11 illustrates diagrammatically a subsequent activation of secure element SE.

In step 91, the auxiliary management circuit of the secure element SE sends on the link LK the ACT_SYNC frame.

The slave SWP interface of the secure element SE is thus considered to be subsequently activated.

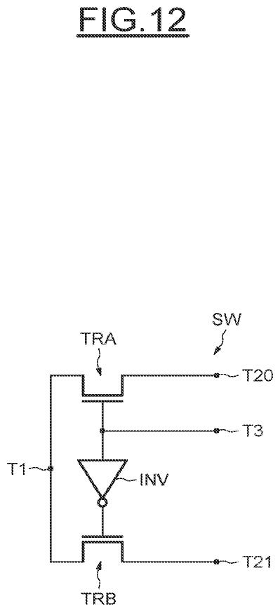

FIG. 12 illustrates diagrammatically an embodiment of an analog multiplexer/demultiplexer switch SW allowing connection with two secure elements.

In this embodiment, the switch SW is a passive switch. It comprises, for example, two NMOS transistors TRA and TRB. The input control T3 of the switch SW is connected to the gate of transistor TRA and the gate of transistor TRB through an inverter INV.

The terminal T20 of the switch SW is connected to one electrode (the drain, for example) of the transistor TRA, while the terminal T21 of the switch SW is connected to the electrode (the drain, for example) of transistor TRB.

The other electrode (the source, for example) of each transistor TRA and TRB are both connected to the terminal Tl of the switch SW.

It is also possible to use an active multiplexer/demultiplexer switch, for example, the one available at the company STMicroelectronics under the reference STG5123.

Such an active multiplexer/demultiplexer switch which is a high-speed CMOS low voltage single analog SPDT (Single-Pole Double Throw) switch or 2:1 multiplexer/demultiplexer switch, has a lower resistivity and a lower input capacity.

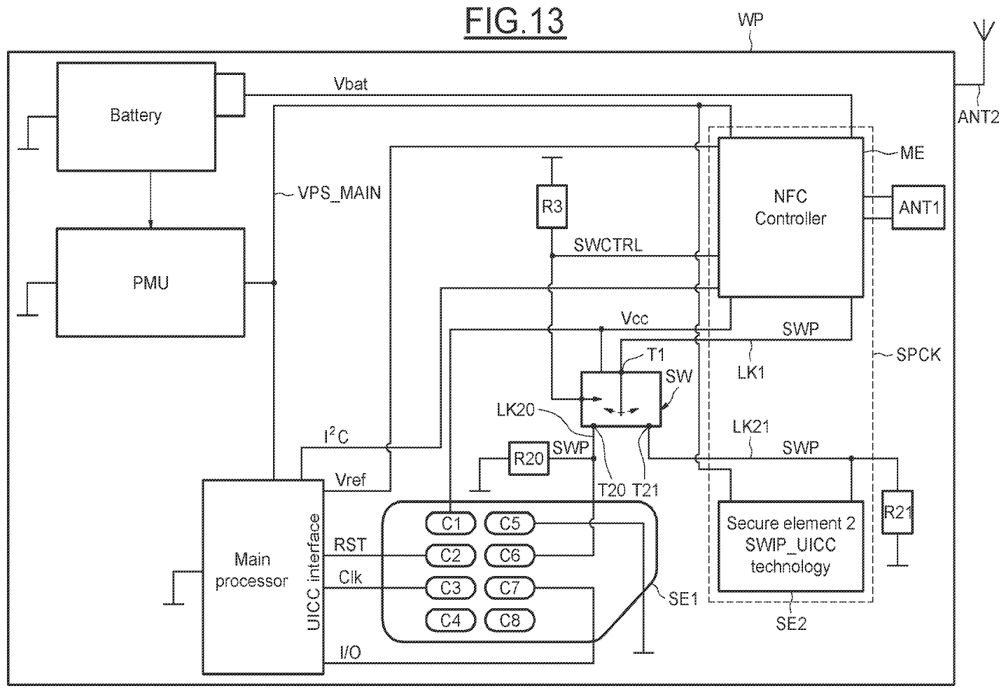

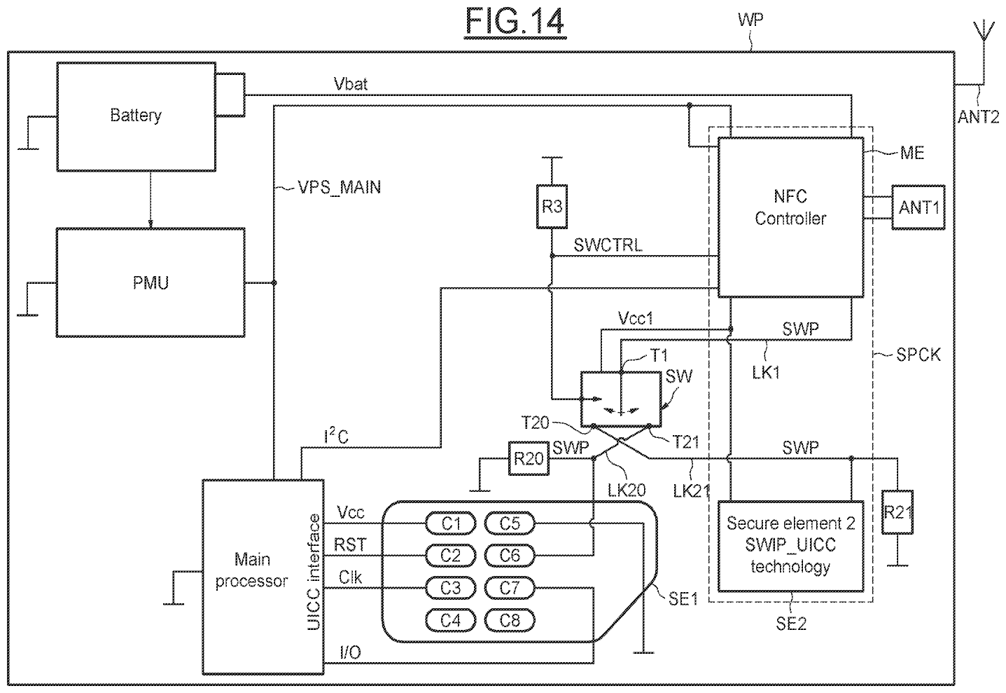

As illustrated in FIG. 13 and FIG. 14, the device DIS may be incorporated in a wireless apparatus WP such as a mobile phone. More precisely, the mobile phone comprises here conventionally a main processor (application or baseband processor) exchanging information with the secure element SE1, for example, a UICC, of the device through signal CLK, RST, I/O compliant with ETSI TS 102 221 permitting thus the telephone functionality through the antenna ANT2.

The NFC controller ME is connected to the main processor through another bus, for example, an I²C bus.

The secure element SE2 is, for example, used for banking operations.

The secure element SE2 is embedded in an integrated circuit containing the NFC controller ME and is, for example, packed with the NFC controller in a single package SPCK.

While the secure element SE2 is thus permanently fixed within the apparatus WP, the secure element SE1 (UTCC) is removably lodged within the apparatus WP and connected to the NFC controller.

The NFC controller is powered by the voltage VPS_main from a power management unit PMU connected to a battery. The NFC controller is also directly connected to the battery.

At last, an antenna ANTI permitting an NFC communication with a contactless device is coupled to the NFC controller.

Information related to two different applications may be thus exchanged between the secure elements SE1 or SE2 through the NFC controller and the antenna ANTI.

In both embodiments disclosed in FIGS. 13 and 14, the NFC controller ME may, in a full power operation mode, either select the secure element SE1 or the secure element SE2 through the switch SW for performing an SWP communication with the selected secure element.

However, in the embodiment disclosed in FIG. 13, in a low power mode (for example, when the battery is off), the secure element SE1 is powered by the NFC controller ME and SWP communication is only possible with this secure element SE1.

The secure element SE1 is connected to terminal T20 of the switch SW and, in a low power mode, the switch SW is forced by the pull-down resistor R3 to be in a configuration where terminal Tl is connected to terminal T20.

As indicated above, the power Vcc of the secure element SE1 is delivered by the NFC controller.

To be compliant with ETSI TS 102 221, which requires the same power value between the main processor and the ETSI TS 102 221 interface of the secure element SE1, an additional signal Vref indicating the voltage value of the main processor is delivered to the NFC controller.

In the embodiment disclosed in FIG. 14, the secure element SE2 is powered by the NFC controller ME in low power mode and SWP communication is only possible between the NFC controller and this secure element SE2 in low power mode.

In this respect, as in a low power mode, switch SW is forced by pull-down resistor R3 into a configuration in which terminal Tl is connected to terminal T20, the secure element SE2 is connected to terminal 20 while secure element SE1 is connected to terminal T21 of the switch SW.

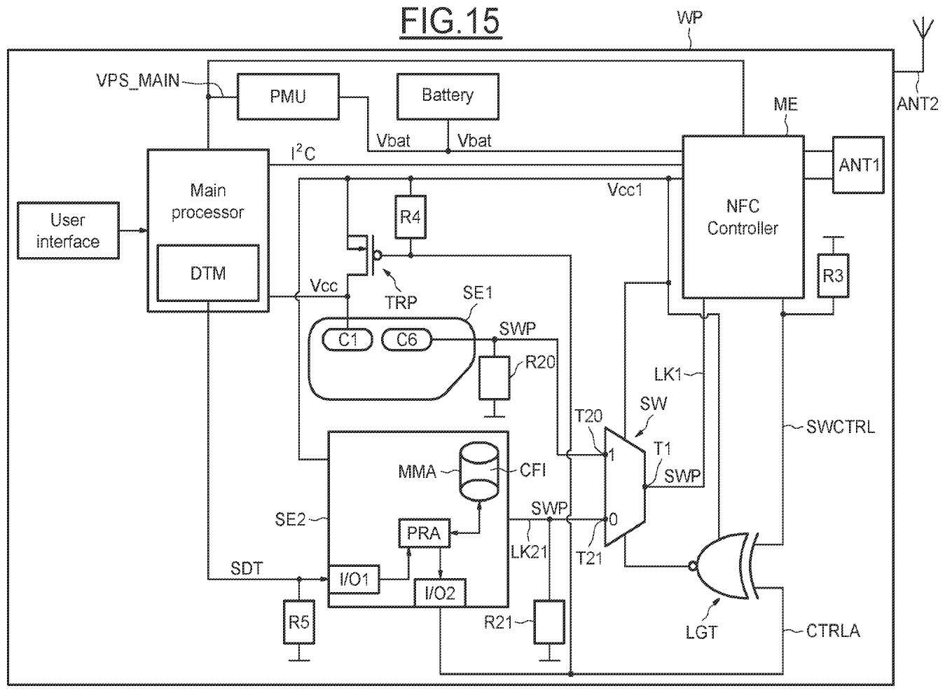

FIGS. 15 to 18 illustrate diagrammatically another embodiment of the present invention permitting, for example, the user of the wireless apparatus to choose which auxiliary element will be able to cooperate with the main element (NFC controller) in the low power mode, i.e. when the battery is off.

As for the embodiments illustrated in FIGS. 13 and 14, the device has a first state in which all the auxiliary elements can operate in a first operation mode, for example, in a full power mode.

As it will be explained now more in details the device illustrated in FIG. 15 has a second state in which at least the secure element SE2 is able to operate in a second operation mode, for example in the low power mode.

Thus, the device comprises auxiliary selection circuit at least partly incorporated in the secure element SE2 and configured, when the device is in its second state, to control the SWP link switching for selecting only one auxiliary element operating in a second operation mode, here the secure element SE2.

More precisely, the secure element SE2 is powered by Vcc1 provided by the NFC controller ME.

The contact C1 of the secure element SE1 is connected to the voltage Vcc provided by the main processor in the full power mode, and to the voltage Vcc1 through a PMOS transistor TRP. The gate of this transistor TRP is connected to Vcc1 through a pull-up resistor R4.

The gate of the transistor TRP is also connected to an input/output port I/O2 of the secure element SE2.

This port I/O2 is also connected to a first input of a EXNOR gate LGT.

The second input of the EXNOR gate LGT is connected to the NFC controller for receiving the control signal SWCTRL in the first operation mode, and to the pull-down resistor R3 to be forced to the logical value “0” in the second operation mode.

The output of the EXNOR gate LGT is connected to the control input of the switch SW.

Both EXNOR gate LGT and switch SW are powered by Vcc1, which is still available in the second operation mode.

The output terminal T20 of the switch is connected to the contact C6 of the secure element SE1, and the input terminal T1 of the switch is switched to the terminal T20 when the signal present at the control input of the switch has the logical value “1”.

The output terminal T21 of the switch is connected to the SWP interface of the secure element SE2, and the input terminal T1 of the switch is switched to the terminal T21 when the signal present at the control input of the switch has the logical value “0”.

The secure element also comprises an auxiliary processing circuit PRA connected to the auxiliary memory circuit MMA, port I/O2, and another input/output port I/O1. The auxiliary processing circuit may be realized by a logic circuit and/or by software.

The main processor is also configured to receive from a user interface an indication designating the auxiliary element, which is chosen to be able to cooperate with the main element (NFC controller) in the low power mode. This indication is processed by the main processor and sent to the NFC controller through the I²C bus, and then to the secure element SE2 during an SWP transaction in full power mode. The auxiliary processing circuit PRA of the secure element is thus configured to store in the auxiliary memory circuit MMA a corresponding configuration indication CFI.

The main processor also comprises a detection circuit configured to detect the passage from the first state of the device (full power operation mode) to the second state (low power operation mode) and to deliver a corresponding detection signal SDT to port I/O1. For example, this signal SDT represents the state ON or OFF of the main processor. For example, when the processor is ON, it sets the signal SDT to the logical value “1”, whereas the signal SDT is forced to the logical value “0” by a pull-down resistor R S when the processor is OFF.

The circuits PRA, MMA, DTM, TRP, LGT, R4 form the auxiliary selection circuit.

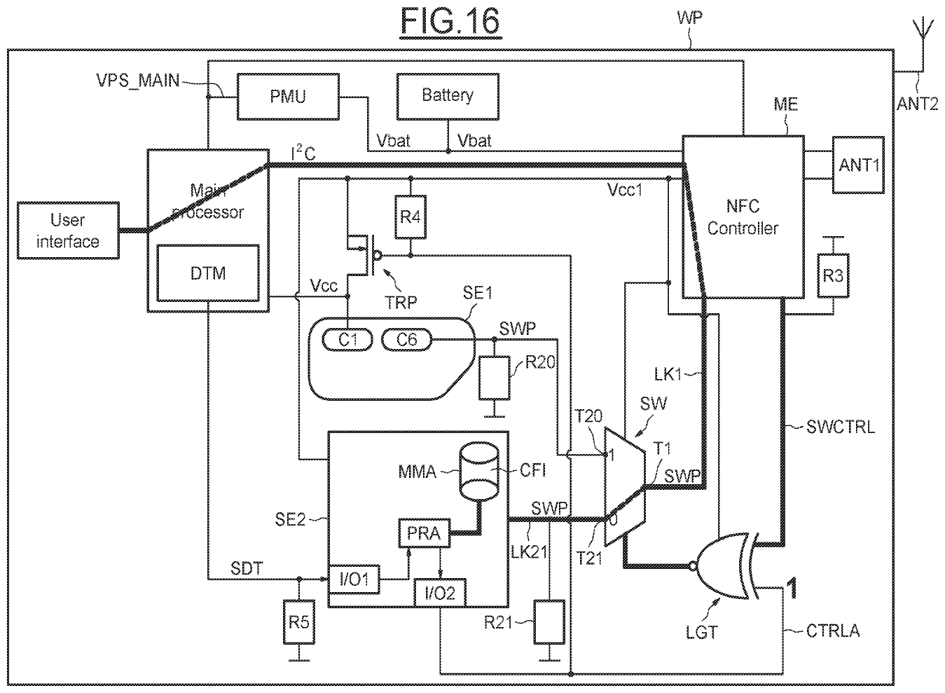

The operation of the device in the first state (full power mode) is now described with reference to FIG. 16.

In this state, all the elements are fully powered by the battery.

The auxiliary control signal CTRLA, provided at the first input of the EXNOR gate LGT, has the logical value “1” due to the pull-up resistor R4.

The transistor TRP is off and the secure element SE1 is powered by the Vcc voltage delivered by the main processor.

In this full power operation mode, the NFC controller ME may either select the secure element SE1 or the secure element SE2 through the switch SW for performing an SWP communication with the selected secure element.

Because the signal CTRLA has the logical value “1” the logical value of the control signal SWCTRL delivered by the NFC controller will be the logical value of the signal fed at the control input of the switch SW.

Further, as explained above, during this full power operation mode, the configuration indication CFI may be delivered to secure element SE2 and stored by the auxiliary processing circuit PRA in the auxiliary memory circuit MMA.

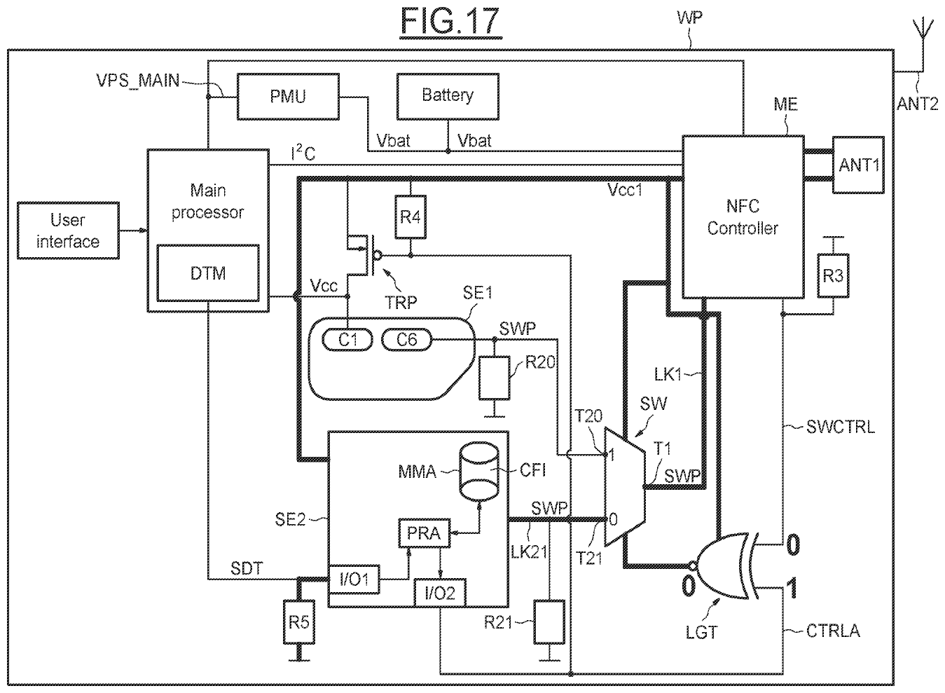

Reference is now made to FIG. 17, to illustrate the case where secure element SE2 is designated by the configuration indication CFI for cooperating with the NFC controller ME through the SWP link during the low power mode.

In the low power mode, the secure element SE2 is powered by the voltage Vcc1 provided by the NFC controller. As in the embodiments illustrated in FIGS. 13 and 14, the NFC controller is powered by the electromagnetic field received by the antenna ANT1 during an NFC communication with a contactless device.

Upon receipt of the detection signal SDT having the logical value “0”, the auxiliary processing circuit PRA read the configuration indication CFI stored in the auxiliary memory circuit and delivers the control signal CTRLA having here the logical value “1”.

Further, the control signal SWCTRL is forced to the logical value “0” by the pull-down resistor R3.

Consequently, the EXNOR gate LGT powered by Vcc1, delivers a logical value “0” to the control input of the switch SW, also powered by Vcc1, allowing the selection of the secure element SE2.

It should be noted here that, in this non-limiting example, the transistor TRP is off, and thus the secure element SE1 is not powered.

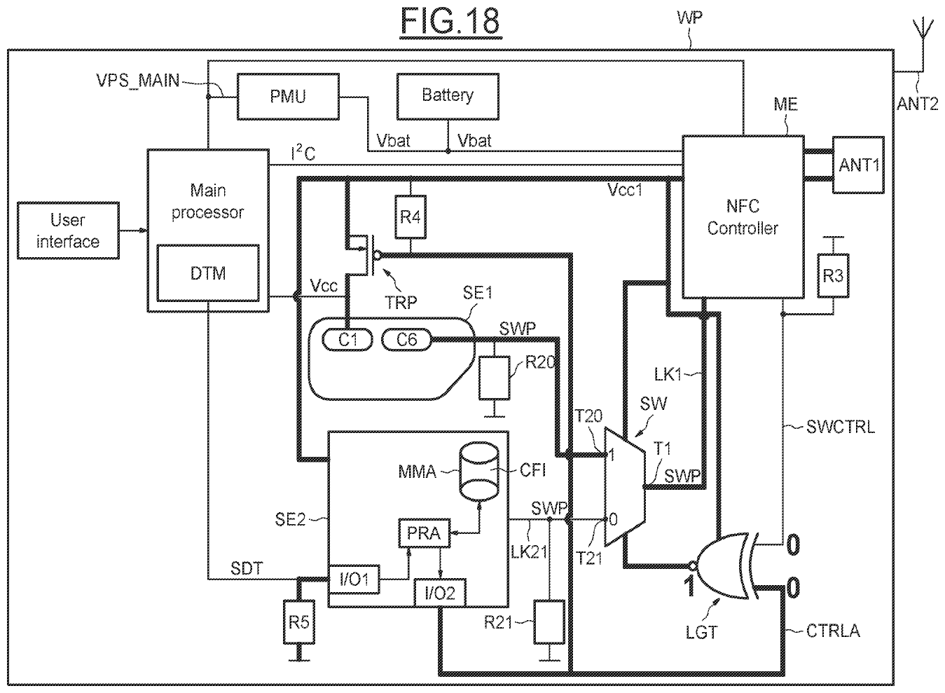

Reference is now made to FIG. 18, to illustrate the case where secure element SE1 is designated by the configuration indication CFI for cooperating with the NFC controller ME through the SWP link during the low operation mode.

In the low power mode, the secure element SE2 is powered by the voltage Vcc1 provided by the NFC controller.

Upon receipt of the detection signal SDT having the logical value “0”, the auxiliary processing circuit PRA reads the configuration indication CFI stored in the auxiliary memory circuit and delivers the control signal CTRLA having here the logical value “0”.

Consequently, the transistor TRP is ON, and the secure element SE1 is powered by the voltage Vcc1.

Since the control signal SWCTRL is forced to the logical value “0” by the pull-down resistor R3, the EXNOR gate LGT powered by Vcc1, delivers a logical value “1” to the control input of the switch SW also powered by Vcc1, allowing the selection of the secure element SE 1.

It should be noted here that the secure element SE1 is powered before being selected by the switch SW due to the delay introduced by the EXNOR gate LGT.

The circuit PRA, MMA, TRP, R4 form also auxiliary power control circuit configured to control the powering of secure element SE1 and SE2 from the configuration indication.

Of course, as both secure elements SE1, SE2 are powered in the low power operation mode, the part LK21 of the SWP link seen by the non-selected secure element SE2 is forced in its deactivated state by the pull-down resistor R21.

According to an aspect of the invention, it is thus possible to exchange information between a main element and two auxiliary elements through a controllable multiplexer/demultiplexer switch without modifying the operating system of the secure element. Further, only a small modification of the operating system of the NFC controller is needed for controlling the analog multiplexer/demultiplexer switch SW.

Although different embodiments of the invention have been disclosed with two secure elements, other embodiments including more than two secure elements connected to the master SWP interface through a multiplexer/demultiplexer switch SW are also possible.

Further, although the analog switch SW has been located outside the main element and the slave elements, it would be possible to integrate the switch (and eventually the EXNOR gate) within the single package SPCK or directly within the main element. In such a case, the outputs of the main element would be, for example, the terminals T20 and T21 of the switch, and terminal Tl of the switch would be connected to the processing circuit of the master interface within the main element.

What is claimed is:

1. A near field communication (NFC) controller for a circuit having a first Universal Integrated Circuit Card (UICC) and a second UICC, the NFC controller comprising a control circuit configured to:
receive a low-power mode indicator from a main processor of the circuit, the low-power mode indicator designating an operation of the first UICC in a low-power operating mode, the second UICC being powered OFF when the first UICC is in the low-power operating mode;
transmit the low-power mode indicator to the first UICC, the transmitting causing an auxiliary processor of the first UICC to retrieve a configuration indicator from an auxiliary memory of the first UICC, the first UICC using the configuration indicator to switch a single wire protocol (SWP) link for operating the first UICC in the low-power operating mode; and
communicate, in the low-power operating mode, with the first UICC, wherein the first UICC is powered by the NFC controller in the low-power operating mode.

2. The NFC controller of claim 1, wherein the control circuit is further configured to exchange communication between the circuit and an external contactless device using an antenna.

3. The NFC controller of claim 2, wherein power provided by the antenna is used to power the NFC controller in the low-power operating mode.

4. The NFC controller of claim 1, wherein the control circuit is further configured to store the configuration indicator in the auxiliary memory in a full-power operating mode of the circuit.

5. The NFC controller of claim 1, wherein the NFC controller provides a voltage to the first UICC in the low-power operating mode.

6. The NFC controller of claim 1, wherein the first UICC and the second UICC conform to a European Telecommunications Standards Institute (ETSI) standard.

7. The NFC controller of claim 1, wherein the control circuit is further configured to:
designate an operation of the second UICC in the low-power operating mode; and
exchange NFC communications with the second UICC.

8. A universal integrated circuit card (UICC) for a device, the UICC comprising a processor and an auxiliary memory, the processor configured to:
receive a low-power mode indicator from a near field communication (NFC) controller of the device, the low-power mode indicator designating an operation of the device in a low-power operating mode;
retrieve a configuration indicator from the auxiliary memory in response to receiving the low-power mode indicator, the UICC using the configuration indicator to switch a single wire protocol (SWP) link for operating the UICC in the low-power operating mode; and
communicate, in the low-power operating mode, with the NFC controller, wherein the UICC is powered by the NFC controller in the low-power operating mode.

9. The UICC of claim 8, wherein the processor is further configured to store the configuration indicator in the auxiliary memory in a full-power operating mode of the device.

10. The UICC of claim 8, wherein the UICC receives a voltage from the NFC controller in the low-power operating mode.

11. The UICC of claim 8, wherein the processor is further configured to communicate with the NFC controller using a communication link having a switch that selectively links the UICC with the NFC controller.

12. The UICC of claim 8, wherein the UICC conforms to a European Telecommunications Standards Institute (ETSI) standard.

13. The UICC of claim 8, wherein the UICC is a first UICC, the device further comprising a second UICC, and wherein the second UICC is activated in response to de-activating the first UICC.

14. The UICC of claim 8, wherein the processor is further configured to receive a signal from a main processor of the device, the signal de-activating the UICC in the low-power operating mode.

15. A near field communication (NFC) controller comprising a control circuit, the control circuit configured to:
exchange, using a single wire protocol (SWP) port, information with a first Universal Integrated Circuit Card (UICC) or a second UICC external to the NFC controller via an SWP communications link;
modulate communication of the NFC controller with one of the first UICC or the second UICC via the SWP communications link;
provide, by a control port coupled to the control circuit, a control signal indicative of whether the NFC controller is to communicate with the first UICC or the second UICC via the SWP communications link;
electrically couple, using a switch arranged along an electrical path between the SWP port and each of the first UICC and the second UICC, the SWP port to one of the first UICC or the second UICC based on the control signal; and
concurrently electrically decouple, using the switch, the SWP port from the other of the first UICC or the second UICC.

16. The NFC controller of claim 15, wherein the control circuit is further configured to generate the control signal based on a determination of whether the NFC controller is to communicate with the first UICC or the second UICC via the SWP communications link.

17. The NFC controller of claim 15, wherein the control circuit is further configured to:
enable the SWP communications link between the NFC controller and the first UICC based on the control signal; and
disable the SWP communications link between the NFC controller and the second UICC based on the control signal.

18. The NFC controller of claim 15, wherein the SWP communications link between the NFC controller and the first UICC comprises an SWP communications channel between the NFC controller and a subscriber identification module (SIM) card.

19. The NFC controller of claim 15, wherein at least one of the first UICC or the UICC comprises a smart card conforming to a European Telecommunications Standards Institute (ETSI) standard.

20. The NFC controller of claim 15, wherein the SWP port, the control circuit, the control port, and the switch are integrated within a single element.
